(19) United States
(12) Patent Application Publication
(10) Pub. No.: US 2022/0048129 A1
(43) Pub. Date: Feb. 17, 2022

(54) ULTRASONIC WELDING DEVICE AND METHOD FOR PRODUCING A METAL FOIL STACK

(71) Applicant: VOLKSWAGEN AG, Wolfsburg (DE)

(72) Inventors: Dennis BÖHM, Wolfernbüttel (DE); Alexander BREUER, Celle (DE)

(73) Assignee: VOLKSWAGEN AKTIENGESELLSCHAFT, Wolfsburg (DE)

(21) Appl. No.: 17/413,900

(22) PCT Filed: Dec. 13, 2019
(86) PCT No.: PCT/EP2019/085024

§ 371 Date: Jun. 14, 2021

(30) Foreign Application Priority Data
Dec. 14, 2018 (DE) 10 2018 221 843.9

(51) Int. Cl. B23K 20/10; B23K 28/02; H01M 10/04; B23K 26/244

(52) U.S. Cl. CPC B23K 20/106; B23K 28/02; H01M 10/0525; B23K 26/244; H01M 10/0413

(57) ABSTRACT

The invention relates to an ultrasonic welding device for introducing an embossed surface into a metal foil stack for a cell of a lithium-ion battery, comprising a sonotrode and an anvil, wherein the anvil or the sonotrode has a number of first protrusions projecting from the working surface thereof, in order to form the, in particular strip-like, embossed surface by compacting the metal foil stack. The invention additionally relates to a method for producing a metal foil stack of metal foils for a cell of a lithium-ion battery, in particular using such an ultrasonic welding device.

Ultrasonic welding device and method for producing a metal foil stack

The invention relates to an ultrasonic welding device comprising a sonotrode and an anvil. The invention also relates to a method for producing a metal foil stack of metal foils, in particular for a cell of a lithium-ion battery.

A cell of a lithium-ion battery has a number of cathodes and anodes. The cathodes and anodes are in this case typically formed by means of metal foils, the cathodes (cathode foils) and the anodes (anode foils) being stacked alternately on top of one another, and a separator (a separator foil) being arranged between the cathodes and the anodes. The cathodes are each electrically conductively connected to one another and in particular additionally to what is referred to as a cell arrester (tab). Analogously, the anodes are each electrically conductively connected to one another and in particular additionally to what is referred to as a cell arrester (tab).

The anode foils and the cathode foils typically have a portion which is coated with an anode material and with a cathode material, respectively. In order to interconnect the anode foils and the cathode foils, respectively, said foils suitably each have a laterally protruding and uncoated second portion, which is also referred to as a flag, and which is provided for connecting to the other foils and possibly to the cell arrester.

For example, the flags of the anodes and the flags of the cathodes are respectively ultrasonically welded together with or without the relevant cell arrester. Such a connection by means of ultrasonic welding is, however, comparatively unreliable, i.e. not durable, such that the connections can become detached from one another over the life of the battery.

Alternatively, the metal foils are welded to one another, with or without the cell arrester, by means of a laser beam. In this case, however, air pockets and/or cavities can occur between the metal foils, as a result of which the electrical conductivity is comparatively low and/or the robustness of the connection is reduced.

A method for producing a foil stack is known from DE 10 2012 018 912 A1, in which method the metal foils to be joined are first pre-fixed and compressed by means of an ultrasonic welding device and are then integrally bonded to one another by means of laser welding (laser beam welding).

In this case, however, in particular due to an insufficiently defined area for the laser beam welding, the laser beam can act outside the region compressed by the ultrasonic welding. Consequently, a connection of the metal foils is comparatively unreliable and/or the robustness of the connection is comparatively low, and the connection of the metal foils to one another and to the cell arrester therefore is also not durable.

The problem addressed by the invention is that of providing a particularly suitable method for producing a metal foil stack, an ultrasonic welding device, and a metal foil stack of this kind. In particular, a particularly reliable connection of the metal foils to one another, and preferably additionally to a cell arrester, is to be provided by means of the ultrasonic welding device and/or by means of the method.

With regard to the ultrasonic welding device, the problem is solved according to the invention by the features of claim 1. With regard to the method, the problem is solved according to the invention by the features of claim 7, and, with regard to the metal foil stack, the problem is solved by the features of claim 10. Advantageous embodiments and developments are the subject matter of the dependent claims. The statements relating to the ultrasonic welding device also apply analogously to the method and to the metal foil stack and vice versa.

The ultrasonic welding device is used to introduce an embossed surface into a metal foil stack, which is provided and designed in particular for a cell of a lithium-ion battery. The ultrasonic welding device has an anvil and a sonotrode, which is also referred to as a horn, the anvil or the sonotrode having a number of first protrusions projecting from the working surface thereof. The first protrusions are used to form the, in particular strip-like, embossed surface by compacting (compressing, pressing) the metal foil stack in the course of the ultrasonic welding process.

In the course of the ultrasonic welding process, the metal foils of the metal foil stack that are stacked on top of one another are pressed against one another by means of the protrusions and the metal foil stack is compressed in the region of the first protrusions. In this way, a depression is pressed into the metal foil stack to form the embossed surface.

The embossed surface in this case defines a region which is acted on by a laser beam following the ultrasonic welding, or a strip along which the laser beam is moved for laser beam welding of the metal foils.

A strip-like surface is in this case understood to be a surface which is longer than it is wide, and in particular extends along a predetermined line (strip) in the longitudinal direction. Furthermore, a number of protrusions is to be understood to be a single protrusion or more than one protrusion.

The embossed surface does not have to be contiguous in this case. Due to the compacting of the metal foil stack, the distance between the individual metal foils is reduced in the region of the embossed surface, in particular a zero gap is set. Furthermore, the formation of cavities, and the resulting air pockets, between the metal foils during laser beam welding is prevented or at least the risk thereof is significantly reduced. Furthermore, due to the compacting, fluctuations in the thickness of the metal foil stack, i.e., in the extension of the metal foil stack in a direction perpendicular to the metal foils, are reduced in the region of the embossed surface. Homogeneous conditions, for example with respect to a penetration depth of the laser beam, are thus provided over the embossed surface for the subsequent laser beam welding process.

In the prior art mentioned at the outset, specifically DE 10 2012 018 912 A1, the anvil and the sonotrode used for compression are roughened as little as possible in order to prevent damage to the metal foils during compression. In this case, for a metal foil thickness of 10 μm, the thickness of the roughening is in the range of from 0.1 μm to 1.0 μm. In contrast thereto, according to the invention, a defined surface is specifically formed for the laser beam entry. The surface on which the laser beam for laser welding is to impinge, or along which the laser is to travel, is defined by means of the protrusions by compressing the metal foils, i.e., by compressing the metal foils by means of the protrusions to form the embossed surface. The first protrusions thus form a type of negative form for the embossed surface. In this way, the embossed surface is formed in the region of the metal foils that is arranged between the first protrusions and the sonotrode or anvil opposite said protrusions.

According to an advantageous development of the ultrasonic welding device, if the sonotrode has the first protrusions, the anvil has a contour which is formed by means of a number of second protrusions projecting from the working surface of said anvil. Alternatively, the anvil has a number of recesses in its working surface, by means of which recesses the contour is formed and which correspond to the first protrusions, in particular to the shape and arrangement of said protrusions with respect to one another.

If the anvil has the first protrusions, the sonotrode has the contour which is formed by means of a number of second protrusions projecting from the working surface of said sonotrode. Alternatively, the sonotrode has the contour which is formed by means of recesses which correspond to the first protrusions, in particular to the shape and arrangement of said protrusions with respect to one another.

In this case, the anvil and the sonotrode are oriented with respect to one another such that the first protrusions and the second protrusions are opposite one another in a direction perpendicular to the working surfaces, i.e., are arranged in opposition. In this way, the embossed surface is introduced in a region of the metal foils that is arranged between the first protrusions and the second protrusions opposite the first protrusions. If the contour is formed by means of the recesses, the anvil and the sonotrode are oriented with respect to one another such that the first protrusions and the recess are opposite one another in a direction perpendicular to the working surfaces, i.e., are arranged in opposition. In particular, in the course of the ultrasonic welding process, the first protrusions engage in the corresponding recesses at least partially in a direction perpendicular to the working surfaces of the sonotrode and the anvil. In this way, the embossed surface is introduced into the metal foils in the recesses, i.e., within the sonotrode or the anvil.

Alternatively, the first protrusions and the second protrusions are offset from the second protrusions, in particular in a grid-like manner, with respect to a direction parallel to the working surfaces. This is also referred to as the intermediate position of the first protrusions and the second protrusions. In the course of the ultrasonic welding process, the embossed surface is thus introduced into a region of the metal foils which is arranged between the first protrusions and the tool opposite said protrusions, i.e. the sonotrode or the anvil. In this case, the embossed surface is arranged between the second protrusions. The first protrusions in particular engage between the second protrusions at least partially in a direction perpendicular to the working surfaces of the sonotrode and the anvil. In this case, the first protrusions and the second protrusions together form a type of negative mold for the embossed surface.

Reference points are expediently provided both on the sonotrode and on the anvil for orienting the anvil and the sonotrode with respect to one another. These reference points are oriented with respect to one another for the ultrasonic welding of the metal foils, for example such that the reference points of the sonotrode are aligned with the reference points of the anvil that correspond thereto in a common direction perpendicular to the working surfaces. The first protrusions and the contour are in this case expediently arranged at a defined distance with respect to the respective reference points and in a defined relative position with respect to the reference points. As an alternative to reference points, a reference line, a reference curve, a reference surface or a combination thereof can also be used.

Sonotrodes have comparatively high requirements with respect to their structure-borne sound conduction and/or their vibration behavior compared to the anvil. The sonotrode can be damaged or misaligned, for example, during orientation. As a result, the anvil is preferably oriented with respect to the sonotrode. For example, the anvil is attached by means of suitable clamping in accordance with the reference points. The tolerances of the reference points with respect to the protrusions and the (manufacturing) tolerances of the protrusions themselves are expediently selected to be as small as possible.

The first protrusions, the recess and/or the second protrusions can, for example, be pyramid-shaped, hemispherical or semi-cylindrical. According to a preferred embodiment, the first protrusions, the recess and/or the second protrusions are in the shape of a prism or truncated pyramid. The relevant prism has, for example, a triangle or a trapezoid as a base, the prism extending in parallel with the corresponding working surface. The embossed surface and, correspondingly, a region of the metal foils to be fused by means of the laser beam, which fused region in particular forms a (laser) weld seam, can be set or is set by means of a suitable selection of the shape of the first protrusions, the recess and/or the second protrusions. In this way, an arrangement, i.e. a position and a course of the laser weld seams can be set, for example according to the tensile forces to be expected and/or a predetermined robustness, i.e. a reliability of the connection. The extension direction of the, in particular prism-shaped or hemispherical, protrusions is oriented parallel or at an angle to the vibration direction of the sonotrode. However, the extension direction of the protrusions is preferably transverse, i.e., perpendicular, to the vibration direction of the sonotrode.

According to a suitable embodiment, the first protrusions, the recess and/or the second protrusions have a height of between 0.02 mm and 1.0 mm, in particular between 0.05 mm and 0.5 mm. The height of the first protrusions and/or of the second protrusions is selected in particular depending on the number of metal foils to be joined and depending on their thickness. The height of the recess is selected in particular on the basis of the height of the first protrusions. The height is in this case understood to mean the extension of the protrusions or the recess in a direction perpendicular to the relevant working surface.

In particular if a cell arrester (tab) is to be fixed, in particular tack welded, to the metal foils by means of the ultrasonic welding device, according to an expedient development, the second protrusions have a lower height than the first protrusions. In this case, the second protrusions are in particular used to hold the cell arrester in the course of the ultrasonic welding process. For example, the height of the second protrusions is less than half the height, in particular less than a quarter of the height, of the first protrusions.

According to a preferred embodiment, the sonotrode has a plurality of first protrusions extending in parallel with one another. In this case, the first protrusions are preferably prism-shaped, preferably with a trapezoid as the base. The second protrusions in particular have a smaller height than the first protrusions, the second protrusions being designed as pyramids. For example, the second protrusions, which are designed as pyramids, are arranged in a plurality of rows which extend in parallel with the prism-shaped first protrusions. In this case, two or three of the rows of the second protrusions are arranged between two of the first protrusions in a direction parallel to the working surfaces and perpendicular to the extension direction of the first protrusions designed as prisms. The first protrusions and the second protrusions are thus arranged offset from one another, in particular in a grid-like manner, in a direction perpendicular to the extension direction of the prisms and parallel to the working surfaces.

The method is used to produce a metal foil stack of metal foils, in particular for a cell of a lithium-ion battery, which cell is designed as a pouch cell, for example. In a first step, metal foils which are stacked on top of one another are provided. These metal foils in particular form the anodes or the cathodes of the (battery) cell.

In a second step, the metal foils, in particular in a laterally protruding portion, which is also referred to as a flag of the relevant metal foil, are compacted and fixed to one another by means of an ultrasonic welding device to form the embossed surface. The ultrasonic welding device is in this case preferably designed according to one of the variants described above.

In a subsequent third step, the metal foils are welded to one another in the region of the embossed surface by means of a laser beam. For this purpose, as described above, the embossed surface is acted on by a laser beam or is moved along a strip defined by means of the embossed surface. For example, a spot seam, a stitch seam or a continuous linear or curved weld seam is produced by means of the laser beam. For example, the laser is also operated with what is referred to as a wobble function, such that the weld seam is comparatively wide and the laser beam travels over a comparatively large region.

Correspondingly, a device for producing the metal foil stack comprises the ultrasonic welding device, preferably in one of the variants described above, and a laser device which generates the laser beam, the laser device expediently being oriented with respect to the first protrusions. This device is in particular therefore used to carry out the method.

According to a suitable development, in the course of the compacting, i.e. in the course of the second step of the method, the electrical cell arrester is fixed to the metal foils. For this purpose, the cell arrester is expediently compacted together with the metal foils by means of the anvil and the sonotrode of the ultrasonic welding device by ultrasonic welding. The cell arrester fixed in this way is then welded to the metal foils in the region of the embossed surface by means of the laser beam.

Alternatively, the cell arrester is only welded to the metal foils in the course of the laser beam welding. In this case, the cell arrester preferably abuts the compacted region, i.e. in the region of the embossed surface of the metal foils. As a result, the formation of cavities between the metal foil stack and the cell arrester in the course of the laser beam welding is prevented or at least reduced.

It is possible for the laser beam to be incident on the metal foils or, alternatively, for the laser beam to be incident on the cell arrester. In other words, in the course of the laser beam welding, either the cell arrester is arranged between the laser device and the metal foil stack, or the metal foil stack is arranged between the laser device and the cell arrester.

According to an expedient embodiment, a working surface of the anvil of the ultrasonic welding device is oriented with respect to the working surface of the sonotrode of the ultrasonic welding device for compacting. The reference points, in particular the reference points of the sonotrode, are in particular used for this purpose.

In addition, in order to weld the metal foils by means of the laser beam, i.e., for the third step of the method, the laser device is oriented with respect to the sonotrode such that the laser beam impinges on the region of the embossed surface or is moved or moves along the embossed surface.

According to an advantageous development, a metal foil stack is produced according to the method described above and/or by means of an ultrasonic welding device in one of the variants described above. In particular, a comparatively reliable integral bonding (joining) of the metal foils to one another and of the cell arrester to the metal foil stack is achieved in this way.

Embodiments of the invention are explained in more detail below with reference to the drawings, which show:

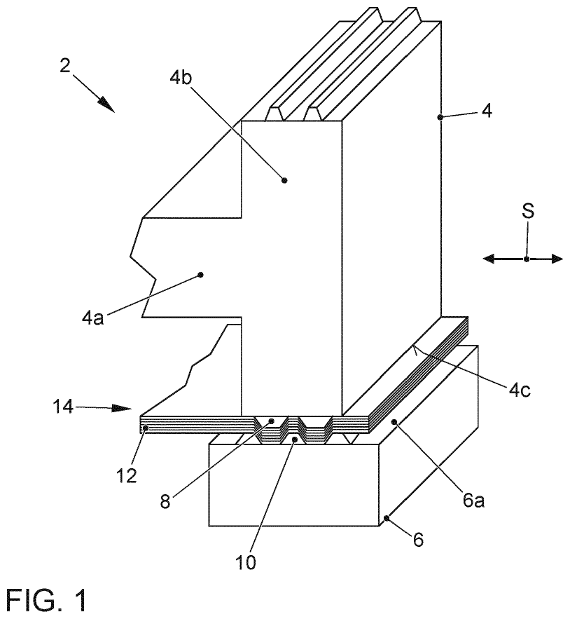

FIG. 1 schematically, in a perspective view, an ultrasonic welding device comprising an anvil and a sonotrode, the sonotrode having first protrusions on the working surface thereof that extend in parallel with one another, by means of which an embossed surface introduced into a metal foil stack between the sonotrode and the anvil,

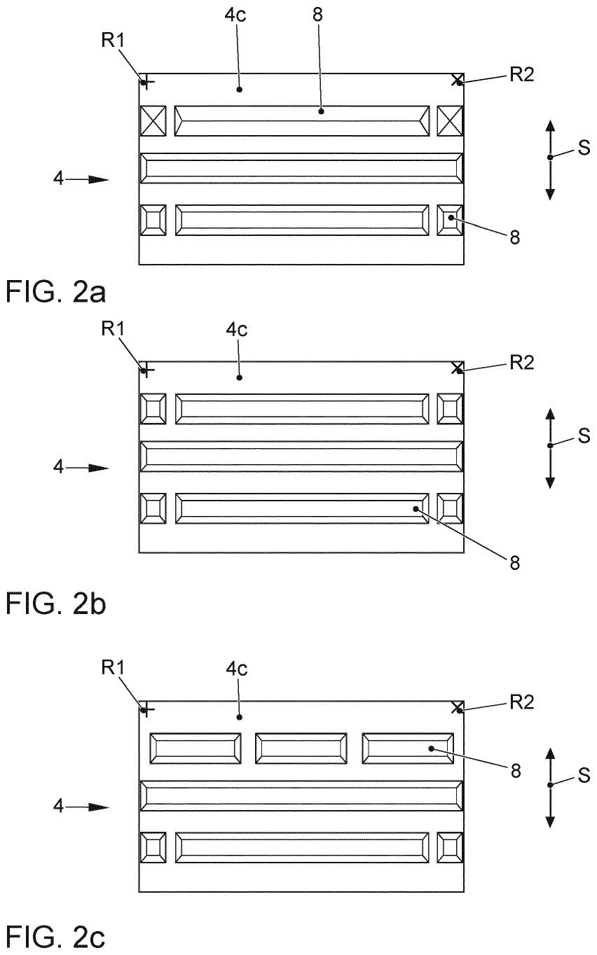

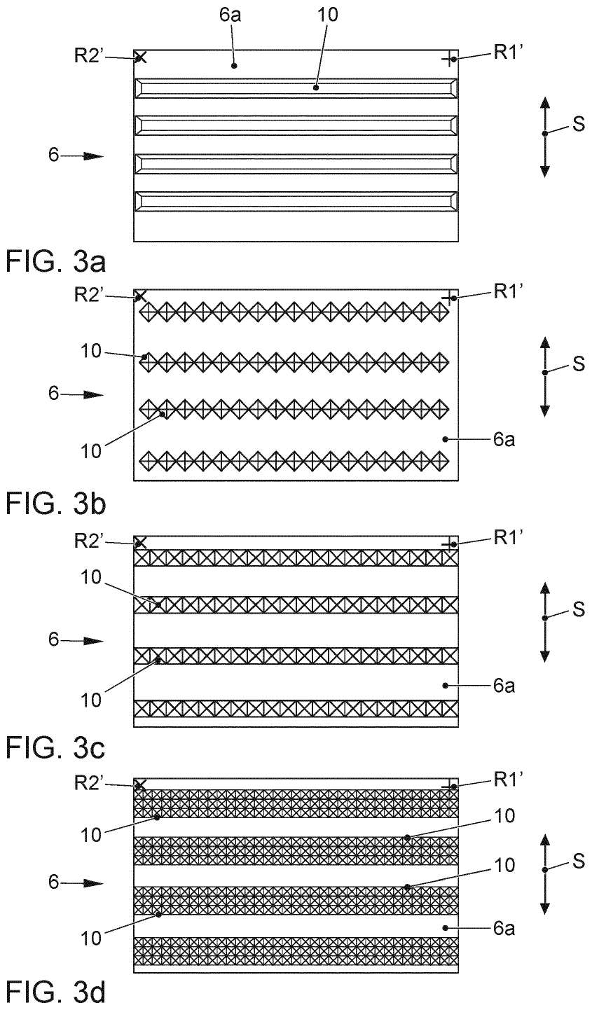

FIG. 2a to c the sonotrode in a schematic plan view, in each case with different embodiments of the first protrusions, FIG. 3a to d the anvil in a schematic plan view, in each case with different variants of a contour formed by means of second protrusions, the second protrusions projecting from the working surface of the anvil,

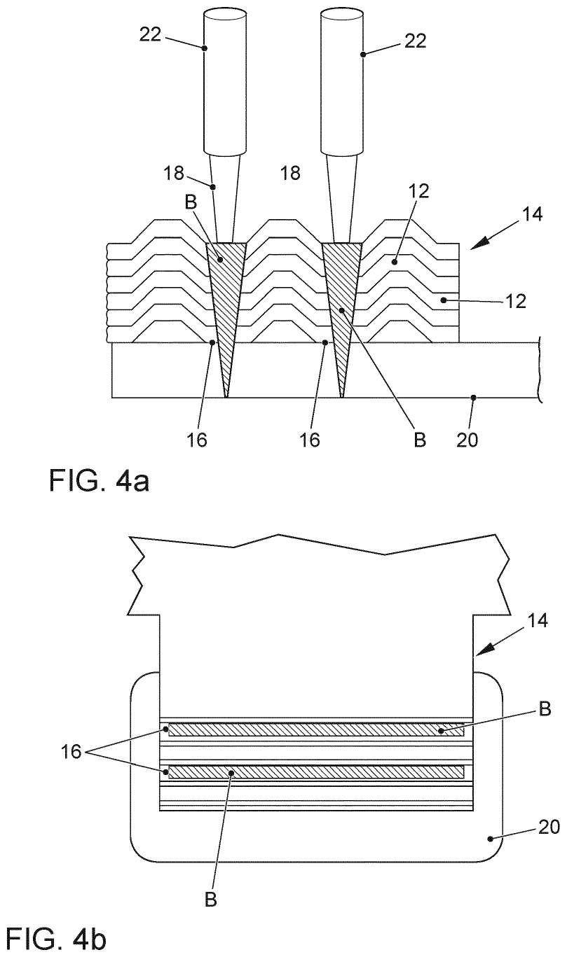

FIG. 4a the metal foil stack in a schematic front view, a cell arrester being arranged on the embossed surface, and the metal foils of the metal foil stack and the cell arrester being integrally joined to one another by means of a laser beam moved along the embossed surface,

FIG. 4b the metal foil stack and the cell arrester arranged thereon in a schematic plan view,

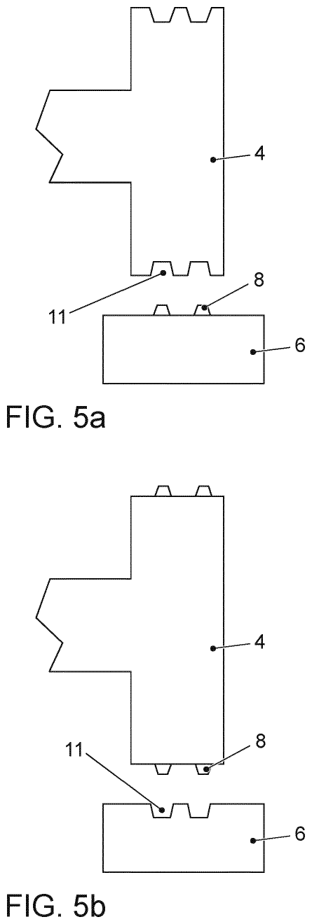

FIG. 5a schematically, in a lateral view, an alternative embodiment of the ultrasonic welding device, the anvil having the first protrusions and the sonotrode having the contour formed by a number of recesses, and

FIG. 5b schematically, in a lateral view, a further alternative embodiment of the ultrasonic welding device, the sonotrode having the first protrusions and the anvil having the contour formed by a number of recesses.

Corresponding parts and dimensions are always provided with the same reference signs in all figures.

FIG. 1 shows a portion of an ultrasonic welding device 2 which has a sonotrode 4 and an anvil 6. The sonotrode 4 is T-shaped with a vertical limb 4a and a horizontal limb 4b extending transversely thereto, the vertical limb 4a being connected to a vibration system (not further shown) by means of which the sonotrode 4 can be caused to vibrate in a vibration direction S extending along the vertical limb 4a. For example, the sonotrode in this case vibrates at a frequency of between 2 kHz and 40 kHz. One of the end faces of the horizontal limb 4b faces the anvil 6 in this case, said end face forming the working surface 4c of the sonotrode 4.

The sonotrode 4 has two first protrusions 8 on the working surface 4c thereof, which working surface faces the anvil 6 and against which the workpiece to be processed rests in the course of an ultrasonic welding process. The anvil 6 has a contour which is formed by means of three second protrusions 10, said protrusions projecting from the working surface 6a of the anvil 6. Both the first protrusions 8 and the second protrusions 10 are each parallel to one another and are prism-shaped, the prisms each having a trapezoid as the base, and the prisms extending in parallel with the working surface 4c or 6a. The first protrusions 8 and the second protrusions 10 extend transversely to the vibration direction S of the sonotrode 4.

The sonotrode 4 and the anvil 6 are oriented with respect to one another such that the first protrusions 8 and the second protrusions 10 are offset from one another in a grid-like manner in a direction parallel to the relevant working surface 4c or 6a and perpendicular to the extension direction of the prisms, i.e., in the vibration direction S of the sonotrode 4.

According to a variant which is not further shown, the anvil 6 and the sonotrode 4 are oriented with respect to one another such that the first protrusions 8 and the second protrusions 10 are opposite one another in a direction which extends perpendicularly to the working surfaces 4c and 6a; in other words, the first protrusions 8 and the second protrusions 10 are arranged in opposition with respect to this direction.

Metal foils 12 stacked on top of one another are introduced between the anvil 6 and the sonotrode 4. The metal foil stack 14 formed by the metal foils 12 stacked on top of one another is provided in particular for a cell (not further shown) of a lithium-ion battery, which is designed, for example, as what is referred to as a pouch cell. When the ultrasonic welding device 2 is used, i.e., in the course of the ultrasonic welding of the metal foils 12, said metal foils are pressed (compressed) by means of the first protrusions 8 to form an embossed surface 16. The embossed surface 16, which can be seen relatively well in particular in FIGS. 4a and 4b, is designed in a strip-like manner. The first protrusions 8 together with the second protrusions 10 in this case form a negative mold for compacting the metal foil stack 14. The embossed surface 16 introduced into the metal foil stack 14 during compaction defines a region or a strip for a laser beam 18 in the course of a laser beam welding process (laser welding process), which is shown in FIG. 4a. Due to the compression of the metal foil stack 16 in the region of the embossed surface 16, which is caused by the ultrasonic welding process, the formation of cavities between the metal foils 12 is prevented or at least reduced and constant (homogeneous) conditions for the laser beam welding are achieved. In this way, a particularly reliable connection of the metal foils 12 to one another can be achieved.

The metal foils only rest in portions on the working surface 6a of the anvil 6. The portions of the metal foils 12 shown in FIG. 1, which portions are provided to be joined to one another, are also referred to as flags. In a manner which is not shown in greater detail, the metal foils 12, with the exception of the flags, are positioned on a support.

In FIGS. 2a to 2c, the sonotrode 4 is shown in a plan view, in each case with different embodiments of the first protrusions 8. In this case, three rows are formed on first protrusions 8 in each case, which protrusions extend perpendicularly to a vibration direction S of the sonotrode 4. According to an embodiment which is not further shown, the rows of the first protrusions 8 extend in parallel with or at an angle to the vibration direction S of the sonotrode 4.

The three rows of the first protrusions 8 are in this case arranged so as to be spaced apart from one another. In FIG. 2a, the row of first protrusions 8 described above has two outer first protrusions 8 designed as pyramids, and a prism-shaped extension 8 arranged therebetween, the base of which is designed as a triangle. The middle row is in this case formed by means of a single prism-shaped first protrusion 8, and the third row is formed by three first protrusions 8, the two outer protrusions each being designed as a truncated pyramid, and the first protrusion 8, which is arranged therebetween and extends from one of the truncated pyramids to the other truncated pyramid of this row, being designed as a prism having a trapezoid as the basic shape.

In the embodiment of the sonotrode 4 shown in FIG. 2b, the middle and lower rows shown correspond to the middle and lower rows of the embodiment according to FIG. 2a. The row of the embodiment of the sonotrode 4 that is described above is formed analogously to the third row of first protrusions 8 thereof, i.e. has two outer truncated pyramid-shaped first protrusions 8 and a prism-shaped first protrusion 8 arranged therebetween.

In contrast to the embodiment in FIGS. 2a and 2b, the embodiment of the sonotrode 4 in FIG. 2c, in the row of first protrusions 8 described above, has three protrusions 8 which are each designed as a prism having a trapezoid as the base, the three prisms extending along a common direction.

The prisms of the embodiments in FIGS. 2a to 2c are beveled toward the working surface 4c at the end with respect to the extension direction thereof.

In FIGS. 3a to 3d, different variants of the second protrusions 10 projecting from the working surface 6a of the anvil 6 are shown. According to FIGS. 3a to 3c, four rows are in each case formed by means of the second protrusions 10, which rows extend in parallel with one another and are offset in a grid-like manner from the rows formed by means of the first protrusions 8 of the sonotrode 4 according to one of the variants of FIGS. 2a to 2c. In other words, the first protrusions 8 do not overlap with the second protrusions 10 in a direction perpendicular to the working surfaces 4c, 6a.

In FIG. 3a, the four rows are each formed by means of a single prism-shaped second protrusion 10. In FIG. 3b, the four rows are each formed by a plurality of pyramid-shaped second protrusions 10, the pyramids each having a square base and the pyramids of the relevant row being arranged next to one another such that one of the diagonals of the basic shapes of all of the pyramids lie on a common straight line.

In the variant of the anvil 6 shown in FIG. 3c, the four rows of the second protrusions 10 are also formed by means of pyramids having square bases. In this case, however, the pyramids are arranged in a row such that two opposite sides of the bases of all of the pyramids extend on two straight lines which are parallel to one another.

In FIG. 3d, a further embodiment of the anvil 6 is shown, in which the second protrusions 10 are each designed as pyramids. The pyramid-shaped second protrusions 10 are arranged in twelve rows, the twelve rows being divided into four groups of three rows each. The four groups are arranged at a distance from one another. In each of the groups, the pyramids are arranged in a checkerboard-like manner with respect to one another. Along the straight line parallel to the vibration direction S and parallel to the working surface 4c or 6a, the first protrusions 8 of the sonotrode 4, which are designed according to one of the embodiments in FIGS. 1 to 2c, and the second protrusions 10 are offset from one another in a grid-like manner in a ratio of 3:1. In other words, a first protrusion 8 and three second protrusions 10 are arranged alternately in this direction.

In further variants which are not shown, the first protrusions 8 and/or the second protrusions 10 are hemispherical or cylindrical, in particular semi-cylindrical.

The first protrusions 8 shown in FIGS. 2a to 2c and 3a to 3d and the second protrusions 10 shown there have a height of between 0.05 mm and 0.5 mm. The second protrusions 10 of FIGS. 3b to 3d have a smaller height than the first protrusions. The second protrusions 10 shown in FIG. 3d have less than a quarter of the height of the first protrusions of FIGS. 2a to 2c.

Furthermore, the sonotrode 4 and the anvil 6 each have two reference points R1 and R2 or R1′ and R2′, by means of which the anvil 6 is oriented with respect to the sonotrode 4. In the oriented state, the reference point R1 corresponds to the reference point R1′ and, analogously, the reference point R2 corresponds to the reference point R2′. The mutually corresponding reference points R1 and R1′ or R2 and R2′ are thus each arranged on a common straight line which extends in a direction perpendicular to the working surfaces 4c and 6a.

As can be seen in FIGS. 4a and 4b, the metal foil stack 14 rests on a cell arrester 20. In this case, the cell arrester 20 abuts the compacted region, i.e. in the region of the embossed surface 16 of the metal foil stack 14. The embossed surface 16 introduced into the metal foil stack 14 defines a region or a strip for the laser beam 18, such that, in the course of the laser beam welding process, the metal foils 12 are joined together and the metal foil stack 14 is joined to the cell arrester 20 by means of the laser beam 18. Therefore, due to the action of the laser beam 18, the metal foils 12 fuse to one another and with the cell arrester 20. The fused region B, which in particular forms a weld seam, is shown hatched for the purpose of improved visibility. Furthermore, for the laser beam welding process, a laser device 22 generating the laser beam 18 is oriented with respect to the sonotrode 4 such that the laser beam 18 moves along the embossed surface 16.

In a variant which is not further shown, the cell arrester 20 is already fixed, in particular tack welded, to the metal foil stack 16 in the course of the compacting of the metal foils 12 by the ultrasonic welding process and is subsequently welded to the metal foil stack 16 in the course of the welding of the metal foils 12 by means of the laser beam 18 in the region of the embossed surface 16.

According to an alternative of FIG. 4a, which is not further shown, the metal foil stack 14 also rests on the cell arrester 20, the cell arrester 20 abutting the compacted region, i.e. in the region of the embossed surface 16 of the metal foil stack 14. In comparison to the variant shown in FIG. 4a, however, the laser device 22 is oriented such that the laser beam 18 impinges on the cell arrester 20. The laser device 20 is oriented such that the laser beam 18 acts in the region of the embossed surface 16 of the metal foil stack 14. The cell arrester 20 is thus arranged between the laser device 22 and the metal foil stack 14.

In summary, in a method for producing the metal foil stack 14, metal foils 12 which are stacked on top of one another are provided in a first step. In a second step, the metal foils 12 are compacted to form the embossed surface 16 by means of the ultrasonic welding device 2, which is designed according to one of the embodiments in FIGS. 1 to 3, the working surface 6a of the anvil 6 of the ultrasonic welding device 2 being oriented with respect to the working surface 4c of the sonotrode 4 for this purpose. In a third step, the metal foils 12 are welded to one another in the region of the embossed surface 16 by means of the laser beam 18, the laser device 22 generating the laser beam 18 being correspondingly oriented with respect to the sonotrode 2.

FIGS. 5a and 5b each show an alternative embodiment of the ultrasonic welding device 2. According to the variant in FIG. 5a, the anvil 6 has the first protrusions 8. The sonotrode 4 has the contour formed by means of a number of recesses 11. According to FIG. 5b, the anvil the sonotrode 4 has the first protrusions 8, and the anvil 6 has the contour formed by means of the recesses 11 that correspond to the first protrusions 8.

The invention is not restricted to the embodiments described above. Rather, other variants of the invention can also be derived therefrom by a person skilled in the art without departing from the subject matter of the invention. In particular, all of the individual features described in connection with the embodiments can also be combined with one another in other ways without departing from the subject matter of the invention.

### LIST OF REFERENCE SIGNS

2 Ultrasonic welding device
4 Sonotrode
4a Vertical limb of the sonotrode
4b Horizontal limb of the sonotrode
4c Working surface of the sonotrode
6 Anvil
6a Working surface of the anvil
8 First protrusion
10 Second protrusion
11 Recess
12 Metal foil
14 Metal foil stack
16 Embossed surface
18 Laser beam
20 Cell arrester
22 Laser device
B Fused region
R1, R1′, R2, R2′ Reference points
S Vibration direction of the sonotrode

1. An Ultrasonic welding device for introducing an embossed surface into a metal foil stack for a cell of a lithium-ion battery, comprising
a sonotrode, and
an anvil,
wherein the anvil or the sonotrode has a number of first protrusions projecting from the working surface to form the, in particular strip-like, embossed surface by compacting the metal foil stack.

2. The Ultrasonic welding device according to claim 1, wherein,
if the sonotrode has the first protrusions, then the anvil has a contour, or if the anvil has the first protrusions, then the sonotrode has the contour,
the contour being formed by means of a number of second protrusions projecting from the relevant working surface, or by means of a number of recesses in the relevant working surface, which correspond to the first protrusions, and
the anvil and the sonotrode being oriented with respect to one another such that the first protrusions and the second protrusions or the recess are opposite one another in a direction perpendicular to the working surfaces, or that the first protrusions are offset from the second protrusions, in particular in a grid-like manner, with respect to a direction parallel to the working surfaces.

3. The Ultrasonic welding device according to claim 1, wherein the first protrusions, the recess and/or the second protrusions are in the shape of a truncated prism or truncated pyramid, the prism-shaped protrusions extending transversely to a vibration direction of the sonotrode.

4. The Ultrasonic welding device according to claim 1, wherein the first protrusions, the recess and/or the second protrusions have a height of between 0.02 mm and 1.0 mm.

5. The Ultrasonic welding device according to claim 2, wherein the second protrusions have a smaller height than the first protrusions, for example less than half the height of the first protrusions, in particular less than a quarter of the height of the first protrusions,

6. The Ultrasonic welding device according to claim 1, wherein the sonotrode has a plurality of first protrusions extending in parallel with one another.

7. A Method for producing a metal foil stack of metal foils, in particular for a cell of a lithium-ion battery, comprising:
providing metal foils which are stacked on top of one another,
compacting the metal foils to form an embossed surface by means of an ultrasonic welding device designed in particular according to claim 1, and
welding the metal foils to one another in the region of the embossed surface by means of a laser beam.

8. The Method according to claim 7, further comprising,
in the course of the welding of the metal foils by means of the laser beam, welding an electrical cell arrester to the metal foils in the region of the embossed surface, or fixing the electrical cell arrester to the metal foils in the course of the compacting and subsequently welding the electrical cell arrester to the metal foils in the course of the welding of the metal foils by means of the laser beam in the region of the embossed surface,
arranging the cell arrester between a laser device which generates the laser beam and the metal foils, or arranging the metal foils between the cell arrester and the laser device.

9. The Method according to claim 7, wherein
for the purpose of compacting, a working surface of an anvil of the ultrasonic welding device is oriented with respect to a working surface of a sonotrode of the ultrasonic welding device, on the basis of reference points of the sonotrode and the anvil, and
for the purpose of welding by means of the laser beam, the laser device is oriented with respect to the sonotrode, on the basis of the reference points thereof, such that the laser beam impinges on the region of the embossed surface or is moved or moves along the embossed surface.

10. A Metal foil stack for a cell of a lithium-ion battery, produced by means of the ultrasonic welding device according to claim 1.

11. A Metal foil stack for a cell of a lithium-ion battery, produced by means of the ultrasonic welding device according to the method of claim 7,

12. A Metal foil stack for a cell of a lithium-ion battery, produced by means of the ultrasonic welding device according to the method according to claim 7.
